(19) United States
(12) Patent Application Publication
(10) Pub. No.: US 2013/0255411 A1
(43) Pub. Date: Oct. 3, 2013

(54) TENSIONING ASSEMBLY FOR CABLE DRIVE

(71) Applicants: John P. McCorkell, Orillia (CA); Fai Koi Tam, Toronto (CA)

(72) Inventors: John P. McCorkell, Orillia (CA); Fai Koi Tam, Toronto (CA)

(73) Assignee: MAGNA CLOSURES, INC., Newmarket, ON (CA)

(21) Appl. No.: 13/993,402

(22) PCT Filed: Dec. 15, 2011
(86) PCT No.: PCT/CA2011/001373

§ 371 Date: Jun. 12, 2013

Related U.S. Application Data
(60) Provisional application No. 61/426,217, filed on Dec. 22, 2010.

(51) Int. Cl. E05F 15/16

(52) U.S. Cl. CPC E05F 15/16
USPC 74/89.22

(57) ABSTRACT

A window regulator assembly having cables for driving one or more lifter plates along rails includes connectors for connecting the ends of cables together. The connectors are connectable together in a ‘use’ position and can be held in a lifter plate in the use position. By having the connectors connect to each other they withstand the tension in the cables when the window regulator assembly is at rest and the lifter plate is only required to withstand the differential tension between first and second cable segments during movement of the lifter plate. This allows the lifter plate to be formed from a relatively lower strength and less expensive material since it is subject to relatively lower stresses than prior art lifter plates.

### FIELD OF THE INVENTION

The present invention relates to tensioning systems for cable driven systems and more particularly to tensioning systems for cable driven window regulators.

### BACKGROUND OF THE INVENTION

Some window regulators in vehicles involve the use of cables with lifter plates attached. A motor-driven drum is used to drive the cables and therefore the lifter plates in one direction or another. When assembling such a system, the cables must be routed around various pulleys that are part of the system and held in the lifter plates in such a way as to prevent their inadvertent release therefrom. The cables must be kept taut so that they do not jump the pulleys during use.

In many systems, one or both of the steps of routing the cables or their connection to the lifter plates can be quite difficult to carry out. If a cable is mounted to the lifter plate first, then the cable must be pulled over the side edges of the pulleys, which can be difficult and which can overstress the pulleys or damage the cables. If the cable is routed around the pulleys first the end of the cable can be very difficult to securely mount to the lifter plate. Additionally, during the assembly operation, the cable is sometimes prone to kinking and/or fraying. Another problem with such systems is that the tension in the cable can cause creep in the system components, many of which are typically made from a plastic material. The prospect of using higher strength plastics or metals to resist creep comes with an inherent cost penalty, however.

It would be advantageous to provide a window regulator that at least partially addresses one or more of the problems noted above.

### SUMMARY OF THE INVENTION

In a first aspect, the invention is directed to a window regulator assembly that includes cables for driving one or more lifter plates along rails, and that includes first and second connectors for connecting first and second ends of the cables together. The first and second connectors are connectable together in a ‘use’ position and can be held in a lifter plate in the use position. The first and second connectors are also connectable in a preliminary connection position in which the cables are under lower tension than they are when the connectors are connected in the use position. This permits an installer of the system to at least preliminarily connect the first and second connectors together even if the tension in the cables is too high for the installer to manually connect the first and second connectors in the ‘use’ position in which the cables are under higher tension.

In an embodiment of the first aspect, the window regulator assembly includes a motor (or some other suitable drum rotation device such as a hand crank), a drum that is rotatable by the drum rotation device, at least one cable, a first connector, a second connector, a biasing member, a rail and a lifter plate. The at least one cable includes a first cable segment having a first end, and a second cable segment having a second end. The at least one cable is drivable by rotation of the drum. The first connector is connected to the first end. The second connector is connected to the second end. The first and second connectors are connectable together in a first position wherein the first and second ends of the cable are a first longitudinal distance apart from each other, and in a second position wherein the first and second ends of the cable are a second longitudinal distance apart from each other. The first longitudinal distance is a distance between the first end and the second end during use of the window regulator assembly. The second longitudinal distance is a distance that induces a reduced amount of tension in the first and second cable segments as compared to the first longitudinal distance. The biasing member is positioned between the end of one of the first and second cable segments and the respective first or second connector to exert a tensioning force in the said one of the first and second cable segments. The lifter plate is configured to receive a window. The lifter plate has a recess for receiving the first connectors connected in the first position. The lifter plate is drivable along the rail by the at least one drive cable.

In a second aspect, the invention is directed to a window regulator assembly that includes cables for driving one or more lifter plates along rails, and that includes first and second connectors for connecting first and second ends of the cables together. The first and second connectors are connectable together in a ‘use’ position and can be held in a lifter plate in the use position. By having the first and second connectors connect to each other they withstand the tension in the cables when the window regulator assembly is at rest and the lifter plate is only required to withstand the differential tension between the first and second cable segments during movement of the lifter plate. The connectors may be made from a relatively high strength material and the lifter plate may be made from a relatively lower strength material since it is subject to relatively lower stresses than lifter plates that have each cable end separately connected thereto. This permits the lifter plate to be made from a relatively less expensive material (and from less material overall) than some lifter plates of the prior art. The material of the connectors may be relatively more expensive, however, it represents a small quantity of material as compared to the lifter plate.

In an embodiment of the second aspect, the window regulator assembly includes a motor (or some other suitable drum rotation device such as a hand crank), a drum that is rotatable by the drum rotation device, at least one cable, a first connector, a second connector, a biasing member, a rail and a lifter plate. The at least one cable includes a first cable segment having a first end, and a second cable segment having a second end. The at least one cable is drivable by rotation of the drum. The first connector is connected to the first end. The second connector is connected to the second end. The first and second connectors are connectable together in a ‘use’ position and are made from a first material having a first strength value. The biasing member is positioned between the end of one of the first and second cable segments and the respective first or second connector to exert a tensioning force in the said one of the first and second cable segments. The lifter plate is configured to receive a window. The lifter plate has a recess for receiving the first connectors connected in the ‘use’ position. The lifter plate is made from a second material having a second strength value that is lower than the first strength value. The lifter plate is drivable along the rail by the at least one drive cable.

In a third aspect, the invention is directed to a window regulator assembly that includes cables for driving one or more lifter plates along rails, and that includes a connector for connecting to an end of one of the cables. The connector has a channel therein which receives the end of the said one of the cables and which receives a biasing member positioned to urge the said one of the cables into tension. The connector is received in a recess in one of the lifter plates. Optionally, the assembly may includes a second connector that connects to the end of another one of the cables. The second connector is also received in a recess in the lifter plate. The recess for the second connector may be the same recess as the recess for the first connector or it may be a separate recess.

In an embodiment of the third aspect, the window regulator assembly includes a motor (or some other suitable drum rotation device such as a hand crank), a drum that is rotatable by the drum rotation device, at least one cable, a first connector, a first biasing member, a rail and a lifter plate. The at least one cable includes a first cable segment having a first end, and a second cable segment having a second end. The at least one cable is drivable by rotation of the drum. The first connector includes a first channel. The first end and a first biasing member are positioned in the first channel. The first connector has a first biasing member retaining tab that is biased towards a locking position. The first biasing member retaining tab is movable out of the locking position during insertion of the first end and the first biasing member into the first channel. In the locking position the first biasing member retaining tab holds the first end and the first biasing member in the first channel. The first biasing member is positioned between the first end and the connector to exert a tensioning force in the first cable segment. The lifter plate is configured to receive a window. The lifter plate has a first connector recess for receiving the first connector. The lifter plate is drivable along the rail by the at least one drive cable.

### BRIEF DESCRIPTION OF THE DRAWINGS

The present invention will now be described by way of example only with reference to the attached drawings, in which:

FIG. 1 is an elevation view of a window regulator assembly with a vehicle window, in accordance with an embodiment of the present invention;

FIG. 2 is a magnified perspective sectional view of a lifter plate from the window regulator assembly shown in FIG. 1;

FIG. 3 is a magnified perspective view of two connectors shown in FIG. 2, prior to their connection together;

FIG. 4 is a magnified perspective view of the two connectors shown in FIG. 3, after their connection together in a ‘use’ position;

FIG. 5 is a magnified perspective view of the two connectors shown in FIG. 3, after their connection together in a preliminary connection position;

FIG. 6 is a magnified perspective sectional view of the lifter plate from the window regulator assembly shown in FIG. 1, prior to insertion of the two connectors into the lifter plate;

FIG. 7a is a magnified perspective view of two alternative connectors to the connectors shown in FIG. 3, prior to their connection together;

FIG. 7b is a magnified plan view of the two alternative connectors shown in FIG. 7a, prior to their connection together;

FIG. 7c is a magnified perspective view of the two connectors shown in FIG. 7a, after their connection together in a ‘use’ position; and

FIG. 8 is a magnified perspective view of an alternative connector to each of the connectors shown in FIG. 3.

### DETAILED DESCRIPTION OF THE DRAWINGS

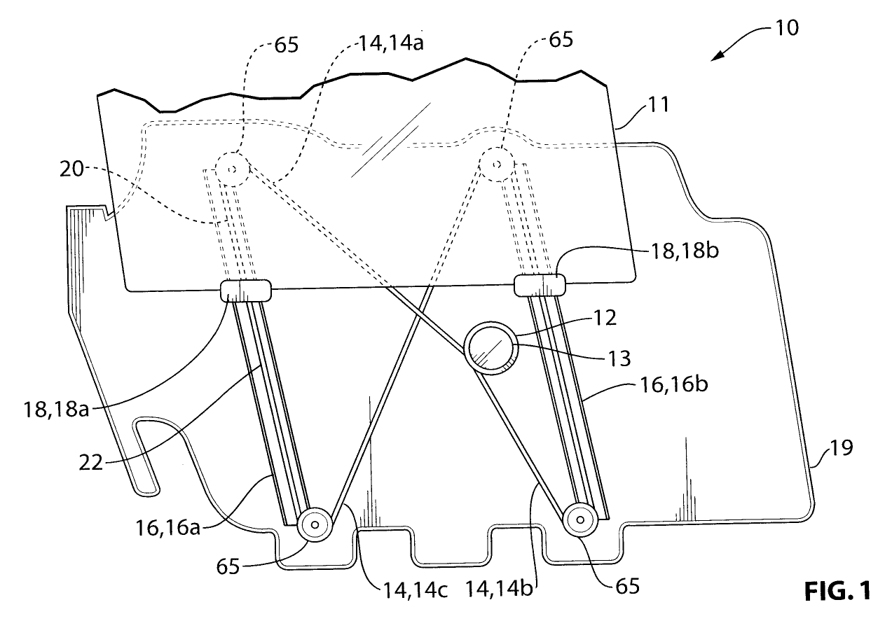

Reference is made to FIG. 1, which shows a window regulator assembly 10 for moving a window 11 in a vehicle door (not shown), in accordance with an embodiment of the present invention. The window regulator 10 includes a motor 12, a drum 13, a set of three drive cables 14, shown individually at 14a, 14b and 14c, two rails 16 shown individually at 16a and 16b, two lifter plates 18, shown individually at 18a and 18b.

The rails 16 may be mounted in any suitable way to the vehicle door. For example the rails 16 may be mounted to a carrier panel 19 that is inside the vehicle door. The lifter plates 18 hold the vehicle window 11 and are slidably mounted on the rails 16. The cable 14a connects between the drum and the first lifter plate 18a. The cable 14b connects between the drum 13 and the second lifter plate 18b. The cable 14c is mounted between the two lifter plates 18. The lifter plates 18 are driven upwardly and downwardly via the cables 14, which are themselves driven by rotation of the drum 13. The drum 13 is rotated in a first direction or a second opposite direction by the motor 12 depending on whether the occupant of the vehicle wishes the window 11 to be raised or lowered. The motor 12 may be a bidirectional electric motor.

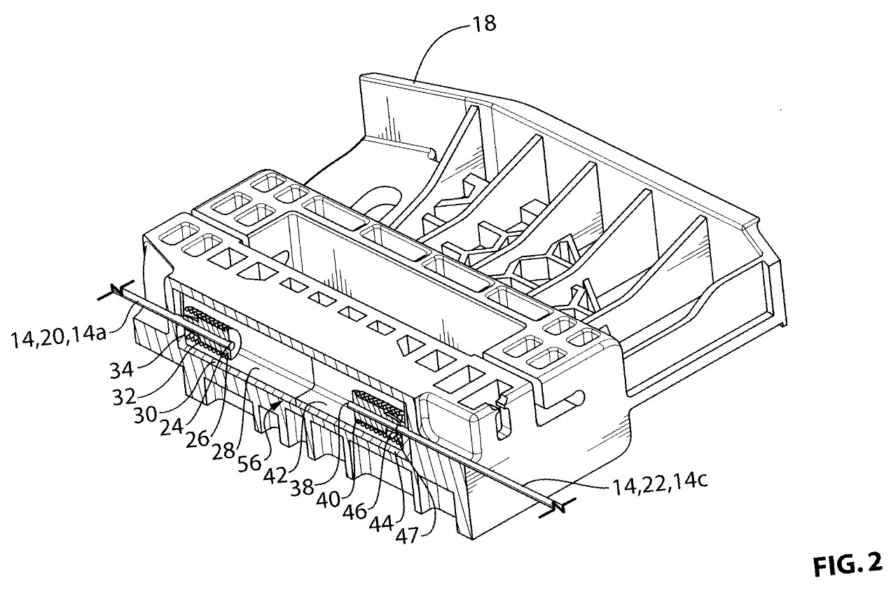

Reference is made to FIG. 2, which illustrates the connection between two segments of the cables 14 and one of the lifter plates 18. The lifter plate 18 may be the first lifter plate 18a, for example, and is shown in section in FIG. 2. One cable segment is shown at 20 and may be referred to as a first cable segment 20. The first cable segment 20 may be part of the first cable 14a (see FIG. 1). The other cable segment is shown at 22 and may be referred to as a second cable segment 22. The second cable segment 22 may be part of the third cable 14c (see FIG. 1).

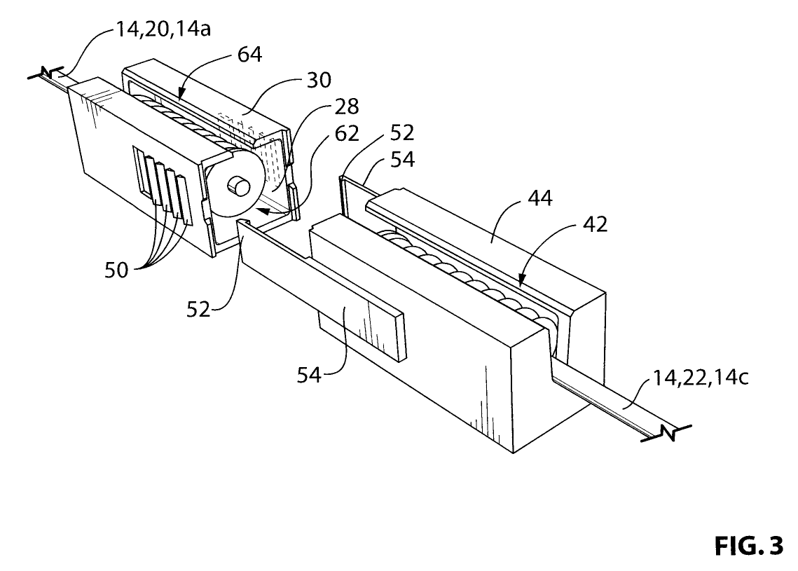

The first cable segment 20 has a first end 24. The first end 24 may have a first ferrule 26 fixedly mounted thereto. The first ferrule 26 may fit slidably in a first channel 28 in a first connector shown at 30 (see also FIG. 3). As shown in FIG. 2, a first biasing member 32 (eg. a compression spring) may be provided between the first ferrule 26 and an end 34 of the first channel 28. The first biasing member 32 biases the first cable end 30 in a first longitudinal direction 36 so as to tension the cable 14a.

The second cable segment 22 has a second end 38. The second end 38 may have a second ferrule 40 fixedly mounted thereto. The second ferrule 40 may fit slidably in a second channel 42 in a second connector shown at 44 (see also FIG. 3). As shown in FIG. 2, a second biasing member 46 (eg. a compression spring) may be provided between the second ferrule 40 and an end 47 of the second channel 42. The second biasing member 46 biases the second cable end 38 in a second longitudinal direction 48 so as to tension the cable 14c.

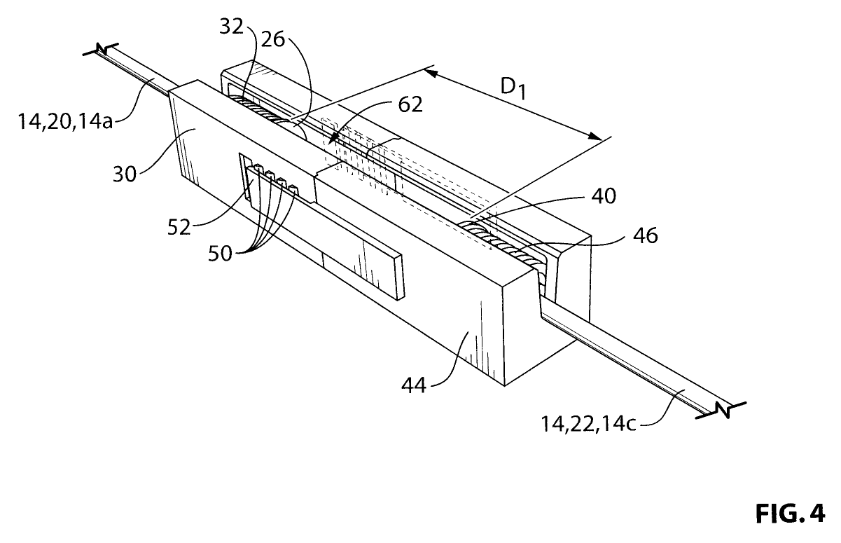

The first and second connectors 30 and 44 may be connectable together outside of the lifter plate 18. Reference is made to FIG. 3, which shows the first and second connectors 30 and 44 approaching each other during assembly of the window regulator 10. The first and second connectors 30 and 44 may connect together in any suitable way. For example, the first connector 30 may include a plurality of longitudinally spaced shoulders 50, and the second connector 44 may include a pair of tabs 52 that are biased via resilient arms 54 towards engagement with the shoulders 50. The shoulders 50 may more generally be referred to as tab receiving elements. FIG. 4 shows the first and second connectors 30 and 44 fully connected together in a ‘use’ position. In other words, the position shown in FIG. 4 is the position that the connectors 30 and 44 will have relative to each other when they are installed in the lifter plate 18 (FIG. 2) and when the window regulator 10 is in use.

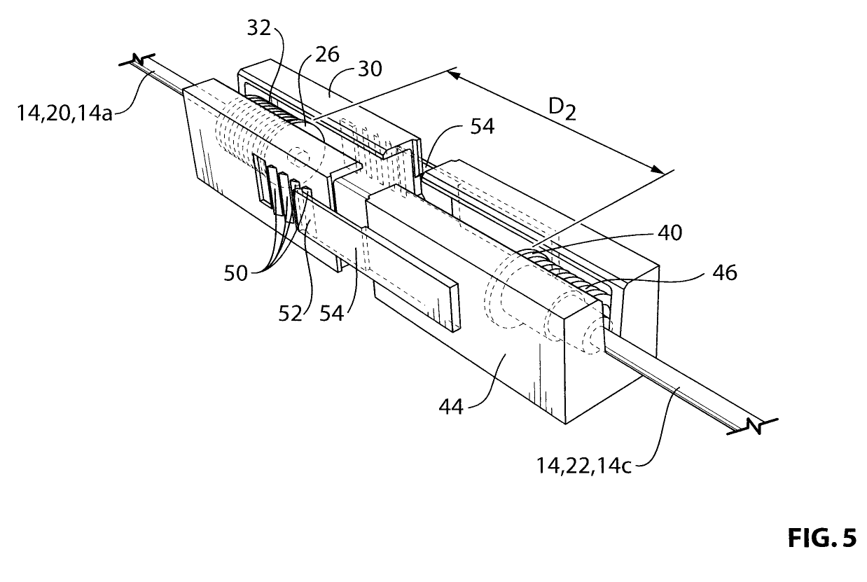

Because there are a plurality of longitudinally spaced shoulders 50 on the first connector 20, however, it is possible to connect the first and second connectors 30 and 44 together in different positions. For example, as shown in FIG. 5, the connectors 30 and 44 are connected to each other in a preliminary connecting position, which is discussed further below.

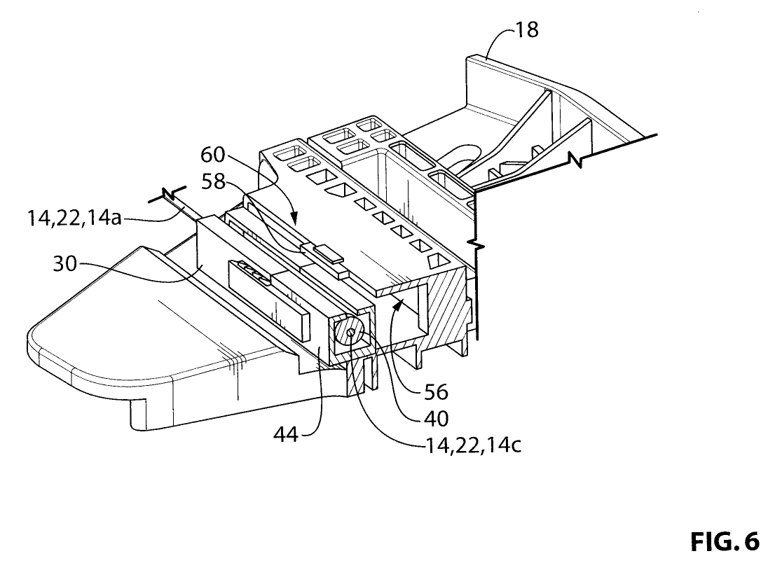

When connected in the ‘use’ position the connectors 30 and 44 are mounted into a recess 56 (FIG. 6) in the lifter plate 18. The recess 56 is configured to capture the connected connectors 30 and 44 so as to prevent the inadvertent withdrawal of the connected connectors 30 and 44 therefrom. For example, the recess may have a tab 58 that extends partially across its mouth shown at 60. The tab 58 is biased towards a locking position but permits the connectors 30 and 44 to push it out of the way (FIG. 6) as they are inserted into the recess 56. FIG. 2 shows the snug fit lengthwise between the connectors 30 and 44 and the recess 56.

The recess 56 is further configured to snugly fit the connectors 30 and 44 along their lengths, as shown in FIG. 2, so that the connectors 30 and 44 and the lifter plate 18 move together as one unit with no play therebetween when the cables 14 are pulled in one direction or the other.

Referring to FIG. 1, when the window regulator 10 is assembled the cables 14 have a certain amount of tension in them so that they are taut, in order to eliminate slop in the assembly. This tension can be relatively high. When the connectors 30 and 44 are connected together in the ‘use’ position (FIG. 4) the connectors 30 and 44 together withstand the tension in the cables 14. In order to withstand the tension, the connectors 30 and 44 may be made of a first material, which has a selected first strength value. The first material may be any suitable material, such as Aluminum or some other suitable metal, or a high-strength polymeric material, such as Polybutylene Terephthalate (PBT), high-temperature nylon (HTN) or Polyphenylene Suphide (PPS). The first strength value referred to above may relate to any suitable strength property, such as tensile strength or creep resistance, for example.

In some prior art lifter plates the cable ends are individually connected to the lifter plate, and so the tension in the cable which urges the withdrawal of the cables from the lifter plate is directly resisted by the material of the lifter plate itself. As a result, some relatively complex lifter plate designs have been proposed in order to assist the lifter plate in holding the cable ends. Furthermore, the material of these prior art lifter plates may in some cases be selected to have selected strength values. Both of these prior art solutions have drawbacks. The complex lifter plate designs typically make installation of the cable end time consuming and difficult. The use of higher strength materials for the lifter plate typically result in higher overall costs for the lifter plate.

For the present window regulator assembly 10 however, the connectors 30 and 44 are connected together and they, together as an assembly, resist the tension in the cables 14. When the drum 13 is rotated to drive the lifter plate 18 up or down, the material of the lifter plate 18 itself only has to resist the differential tension that is present due to the drum rotation (ie. the resultant drop in tension on one cable 14 and the resultant increase in tension on the other cable 14). As a result, the amount of stress incurred by the lifter plate 18 is lower than it would be if the lifter plate 18 also had to resist the tension that exists in the cables 14 at rest (ie. if the cable ends weren't connected to each other).

As a result, the lifter plate 18 may be made from a material (that may be referred to as a second material) that may have a strength value (referred to as a second strength value) that is relatively lower than the first strength value. Additionally, the amount of material that is incorporated into the lifter plate 18 may be reduced relatively to a lifter plate that has to provide resistance on its own to the tension in the cables. As a result, the lifter plate 18 may be relatively inexpensive. It is also possible that in some embodiments, the lifter plate 18 with the connectors 30 and 44 installed therein would be lighter than a prior art lifter plate that did not include connectors 30 and 44. While the lifter plate 18 may be made from a relatively weaker material than the material of the connectors 30 and 44, it may alternatively in other embodiments be made from any material, such as a material that is not weaker than (ie. at least as strong as) the material of the connectors 30 and 44. In an embodiment, the lifter plate 18 may be made from steel.

The installation of the cables ends 24 and 38 into the lifter plate 18 may be relatively simple as compared to some prior art window regulators. The cable end 24 may be provided to the installer with the ferrule 26 and the biasing member 32 thereon. The first ferrule 26 and the first biasing member 32 are slid into the channel 28 on the first connector 30 via a mouth 62, while the first cable segment 20 passes through a slot 64 along the length of the connector 30. A similar operation is carried out between the second cable end 38 and the second connector 44. Once the connectors 30 and 44 are connected to the cable ends 24 and 38, the connectors 30 and 44 are connected to each other to form a connector assembly (FIG. 4). The connector assembly is then inserted into the recess 56 in the lifter plate 18. This assembly process is easier to carry out and less time consuming than in some prior art window regulators wherein, for example, the cable ends are inserted into serpentine channels in the lifter plate.

It may be in some circumstances, however, that it may be difficult for the installer to manually bring the connectors 30 and 44 together to couple them in the ‘use’ position shown in FIG. 4 due to the high tension in the cable segments 20 and 22. As noted, the connector 30 includes a plurality of shoulders 50 so that the connectors 30 and 44 can connect in the preliminary connection position shown in FIG. 5. Thus, the installer can connect them in the preliminary connection position and can then insert the connected connectors 30 and 44 into a suitable device (not shown) to bring them together to the ‘use’ position.

Put another way, the connectors 30 and 44 are connectable in a first position, which is the ‘use’ position, wherein the cable ends 24 and 38 are spaced apart by a first longitudinal distance D1 (see FIG. 4), and they are connectable in a second position (and optionally in any suitable number of other positions). In the second position, which is a preliminary connection position, the cable ends 24 and 38 are spaced apart by a second longitudinal distance D2 (see FIG. 5). The term ‘longitudinal’ refers to a direction of the cable segments 20 and 22 that mount to and act on the lifter plate 18 to drive the lifter plate 18 up and down.

By contrast, in some prior art window regulators, the installer has to manually pull the cables and install them on the lifter plate in their ‘use’ position—there is no preliminary connection position for the cables on the lifter plates. This may be difficult for an installer as the tension in the cable can be relatively high.

The biasing members 32 and 46 assist in maintaining tension in the cables 14, in particular during movement of the lifter plates 18. When the lifter plates 18 are moved the cable segment on one side of each lifter plate 18 is pulling that lifter plate 18 and the cable segment on the other side of the lifter plate is under less tension. In order to prevent the cable 14 that is under less tension from becoming too slack the biasing members 32 and 46 each exert a minimum tensile force on their respective cable ends 24 and 38. By having this minimum tensile force, the cables 14 are less likely to jump the pulleys or the like shown at 65 at the tops and bottoms of the rails 16 in FIG. 1 during movement of the lifter plates 18.

When the connectors 30 and 44 are connected in the use position, the biasing members 32 and 46 are substantially completely compressed, so that there is no play in the assembly. In other words, when the drum 13 (FIG. 1) is turned, the movement of the cable is immediately translated into movement of the lifter plate 18. By contrast, if the biasing members 32 and 46 were not completely compressed, then some initial turning of the drum 13 could potentially cause some compression of the biasing member 32 or 46 prior to movement of the lifter plate 18.

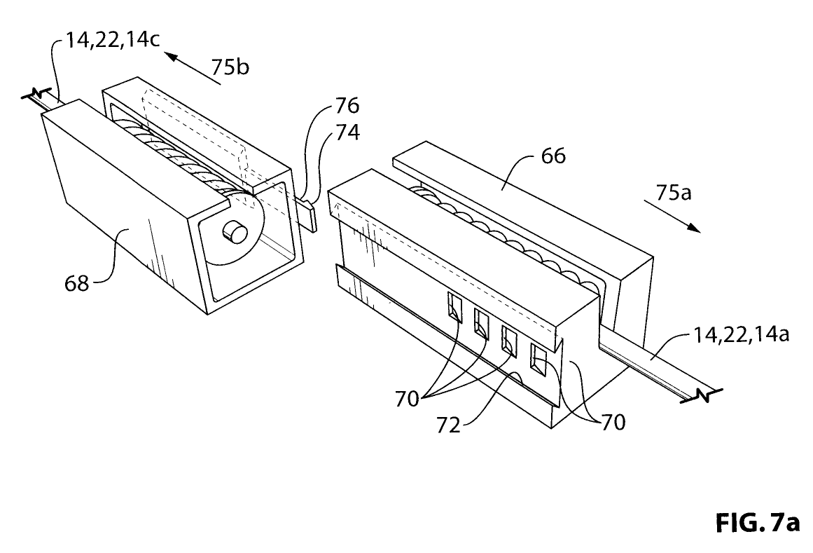

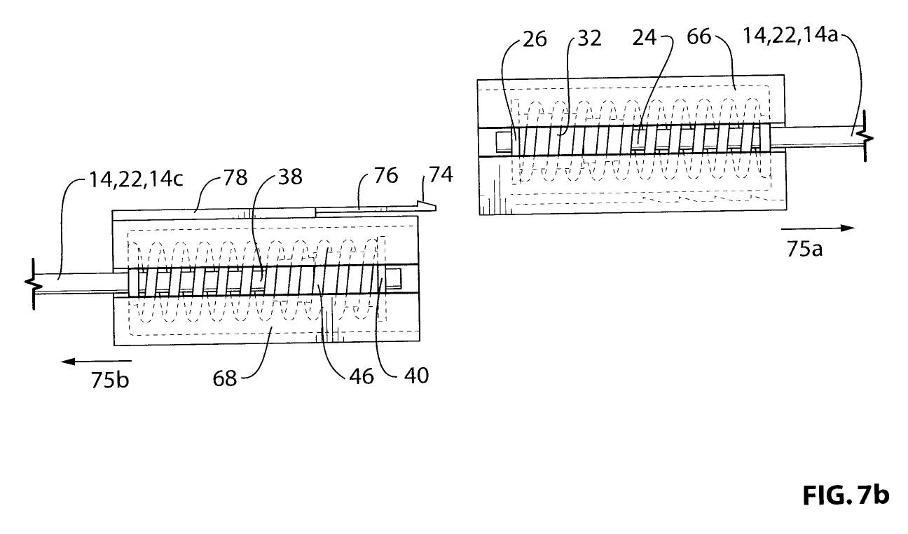

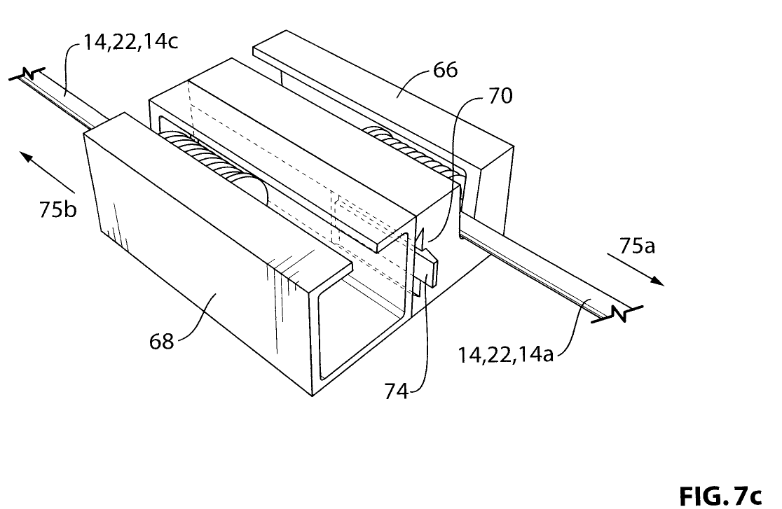

It is noted that in the embodiment show in FIGS. 2-6, when the connectors 30 and 44 are connected (in particular, when connected in the use position), the first and second connectors are coaxial. Reference is made to FIGS. 7a, 7b and 7c, which show alternative first and second connectors 66 and 68, which, when connected, (in particular in a use position), are parallel. The connectors 66 and 68 may be similar to the connectors 30 and 44, except that the structure on the first connector 66 for connecting to the second connector 68 includes a plurality of longitudinally spaced shoulders 70, and a first dovetail joint portion 72. The structure on the second connector 68 for connecting to the first connector 66 includes a tab 74 that is biased via resilient arm 76 towards engagement with the shoulders 70, and a second dovetail joint portion 78. The shoulders 70 thus constitute tab-receiving elements. By sliding the first and second connectors 66 and 68 together, the two dovetail joint portions 72 and 78 engage each other to lock the first and second connectors 66 and 68 together laterally. The engagement of the tab 74 with one of the shoulders 70 prevents the withdrawal of the first and second connectors 66 and 68 from each other longitudinally due to the tension in the cables 14 which pulls the cable segments 20 and 22 in the directions shown by arrows 75a and 75b. The connectors 66 and 68 shown in FIGS. 7a, 7b and 7c connect to form an assembly that is shorter longitudinally than the connected connectors 30 and 44 shown in FIG. 2, and so the connectors 66 and 68 may be used when the lifter plate 18 cannot be made tall enough to accommodate the length of the connected connectors 30 and 44. In the embodiment shown in FIGS. 7a-7c, the first and second cable ends 24 and 38 have both included are the same as they are in the embodiment shown in FIG. 2, and each engages its respective connector 66 or 68 by way of a ferrule 26 or 40 and a biasing member 32 or 46.

It will be noted that in the embodiments shown in FIGS. 2-7c, the cable ends 24 and 38 have engaged the connectors via biasing members 32 and 46. It is alternatively possible for one of the connectors to lack a biasing member. For example, in a configuration where three cables 14a, 14b and 14c are provided, each of the cables 14a and 14b may be provided with a biasing member 32 or 46 on the end that connects to one of the lifter plates 18, however the cable 14c may optionally not have a biasing member at its ends since it is at least theoretically in tension regardless of the direction of travel of the lifter plates 18. Thus, each lifter plate 18 will have one connector with a biasing member and one connector without a biasing member. The advantages of providing the connectors as described above are nonetheless applicable.

In the embodiments described herein, the connectors were shown to connect together at a plurality of positions. To achieve this, the first connector was provided with a plurality of tab receiving elements. It is alternatively possible however, for the first connector to be provided with only one tab-receiving element so that the first and second connectors are only connectable in one position (the use position).

As can be seen in FIG. 7c in particular, the cable segments 20 and 22 are offset from each other in this embodiment. Thus, this embodiment is used in situations where some offset of the cables 14 (and therefore some offset of the forces exerted on the lifter plate 18) is permissible.

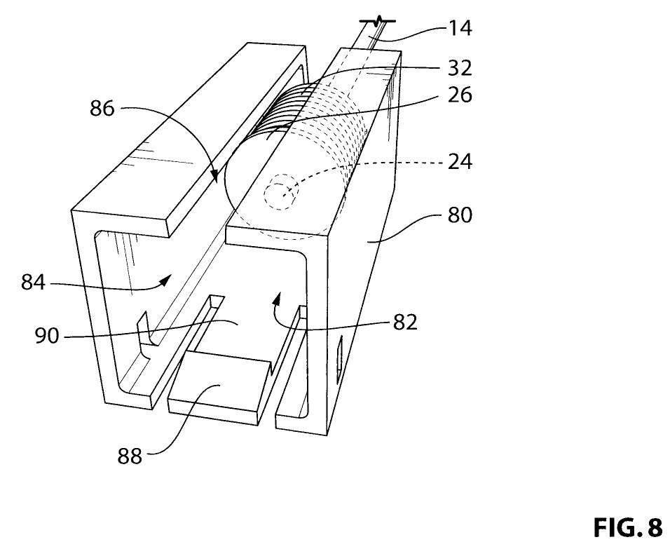

With reference to FIG. 8, in yet another embodiment it is possible to provide a connector, as shown at 80 for each cable end 24 and 38 but wherein the connectors 80 do not connect to each other. In FIG. 8, for exemplary purposes, the cable end 24 is shown. The connector 80 includes a channel 82 with a mouth 84, a slot 86 for the cable 14 during insertion of the cable end 24, ferrule 26 and biasing member 32 into the channel 82, and a tab 88 that is on a biasing arm 90 that can be moved out of the way during insertion of the cable end 24, ferrule 26 and biasing member 32 into the channel 82, and that is biased to a locking position wherein it holds the aforementioned components in the channel 82. This facilitates the connecting of the cable end 24 to the lifter plate. The lifter plate may be similar to the lifter plate 18 and may have a recess similar to recess 56 that can hold two connectors. Thus the recess may equally be referred to as a first connector recess and as a second connector recess. Alternatively the lifter plate could be provided with an individual compartment for each connector 80 and would thus have a separate first connector recess and a second connector recess. It is also possible to provide an embodiment, wherein one connector 80 is provided on one cable end (eg. cable end 24) and the other cable end (eg. cable end 38) is connected to the lifter plate in some other way (eg. in a serpentine channel). The connector 80 may be made from the same materials as the connectors 20 and 22. The lifter plate may require some strengthening relative to the lifter plate 18 so as to resist the tension in the cable 14 which acts on the connector 80 to stretch the recess in which the connector 80 is positioned.

The window regulator assembly 10 shown in FIG. 1 is a dual rail assembly that incorporates two rails 16 and two lifter plates 18. It will be understood that some embodiments of the invention can be single rail window regulator assemblies. In such embodiments, two cables 14 would be provided instead of the three cables 14 shown in FIG. 1.

A motor 12 has been disclosed and shown as being operatively connected to the drum 13 for driving the rotation of the drum 13. It will be noted, however that any other suitable drum rotation device may alternatively be provided to cause rotation of the drum 13. For example, in some vehicles, a hand crank (not shown) may be provided as the drum rotation device instead of a motor 12. The hand crank would be manually rotatable by an occupant of the vehicle to cause rotation of the drum 13.

While the above description constitutes a plurality of embodiments of the present invention, it will be appreciated that the present invention is susceptible to further modification and change without departing from the fair meaning of the accompanying claims.

1. A window regulator assembly, comprising:
a drum that is rotatable;
a drum rotation device operatively connected to the drum to cause rotation of the drum;
at least one cable, wherein the at least one cable includes a first cable segment having a first end, and a second cable segment having a second end, wherein the at least one cable is drivable by rotation of the drum;
a first connector connected to the first end;
a second connector connected to the second end,
wherein the first and second connectors are connectable together in a first position wherein the first and second ends of the cable are a first longitudinal distance apart from each other, and in a second position wherein the first and second ends of the cable are a second longitudinal distance apart from each other, wherein the first longitudinal distance is a distance between the first end and the second end during use of the window regulator assembly, and wherein the second longitudinal distance is a distance that induces a reduced amount of tension in the first and second cable segments as compared to the first longitudinal distance;
a biasing member positioned between the end of one of the first and second cable segments and the respective first or second connector to exert a tensioning force in the said one of the first and second cable segments;
a rail; and
a lifter plate configured to receive a window, wherein the lifter plate has a recess for receiving the first connectors connected in the second position, wherein the lifter plate is drivable along the rail by the at least one drive cable.

2. A window regulator assembly as claimed in claim 1, wherein the biasing member is positioned between the first end of the first cable segment and the first connector to exert a tensioning force in the first cable segment, and wherein the window regulator assembly further comprises a biasing member positioned between the second end of the second cable segment and the second connector to exert a tensioning force in the second cable segment.

3. A window regulator assembly as claimed in claim 2, wherein the first and second connectors are made from a first material having a first strength value, and wherein the lifter plate is made from a second material having a second strength value that is lower than the first strength value, wherein the lifter plate is drivable along the rail by the at least one drive cable.

4. A window regulator assembly as claimed in claim 3, wherein the first and second connectors are made from a metal and the lifter plate is made from a polymeric material.

5. A window regulator assembly as claimed in claim 3, wherein the first and second connectors are made from aluminum and the lifter plate is made from a polymeric material.

6. A window regulator assembly as claimed in claim 3, wherein the first and second connectors are made from a first polymeric material and the lifter plate is made from a second polymeric material.

7. A window regulator assembly as claimed in claim 3, wherein the first connector includes a plurality of longitudinally space tab-receiving elements and the second connector includes a tab that is biased towards engagement with the tab-receiving elements.

8. A window regulator assembly as claimed in claim 2, wherein, when connected in the first position, the first and second connectors are coaxial.

9. A window regulator assembly as claimed in claim 2, wherein, when connected in the first position, the first and second connectors are parallel.

10. A window regulator assembly as claimed in claim 1, wherein the drum rotation device includes a motor.

11. A window regulator assembly, comprising:
a drum that is rotatable;
a drum rotation device operatively connected to the drum to cause rotation of the drum;
at least one cable, wherein the at least one cable includes a first cable segment having a first end, and a second cable segment having a second end, wherein the at least one cable is drivable by rotation of the drum;
a first connector connected to the first end;
a second connector connected to the second end,
wherein the first and second connectors are connectable together in a use position and are made from a first material having a first strength value;
a biasing member positioned between the end of one of the first and second cable segments and the respective first or second connector to exert a tensioning force in the said one of the first and second cable segments;
a rail; and
a lifter plate configured to receive a window, wherein the lifter plate has a recess for receiving the first connectors when the first connectors are connected together in the use position, and wherein the lifter plate is made from a second material having a second strength value that is lower than the first strength value, wherein the lifter plate is drivable along the rail by the at least one drive cable.

12. A window regulator assembly as claimed in claim 11, wherein the biasing member is positioned between the first end of the first cable segment and the first connector to exert a tensioning force in the first cable segment, and wherein the window regulator assembly further comprises a biasing member positioned between the second end of the second cable segment and the second connector to exert a tensioning force in the second cable segment.

13. A window regulator assembly as claimed in claim 12, wherein the first and second connectors are made from a metal and the lifter plate is made from a polymeric material.

14. A window regulator assembly as claimed in claim 12, wherein the first and second connectors are made from aluminum and the lifter plate is made from a polymeric material.

15. A window regulator assembly as claimed in claim 12, wherein the first and second connectors are made from a first polymeric material and the lifter plate is made from a second polymeric material.

16. A window regulator assembly as claimed in claim 12, wherein the first connector includes a plurality of tab-receiving elements and the second connector includes a tab that is biased towards engagement with the tab-receiving elements.

17. A window regulator assembly as claimed in claim 12, wherein, when connected in the use position, the first and second connectors are coaxial.

18. A window regulator assembly as claimed in claim 12, wherein, when connected in the use position, the first and second connectors are parallel.

19. A window regulator assembly as claimed in claim 11, wherein the drum rotation device includes a motor.

20. A window regulator assembly, comprising:
a drum that is rotatable;
a drum rotation device operatively connected to the drum to cause rotation of the drum;
at least one cable, wherein the at least one cable includes a first cable segment having a first end, and a second cable segment having a second end, wherein the at least one cable is drivable by rotation of the drum;
a first connector including a first channel, wherein the first end and a first biasing member are positioned in the first channel, and wherein the first connector has a first biasing member retaining tab that is biased towards a locking position, wherein the first biasing member retaining tab is movable out of the locking position during insertion of the first end and the first biasing member into the first channel and wherein in the locking position the first biasing member retaining tab holds the first end and the first biasing member in the first channel, wherein the first biasing member is positioned between the first end and the connector to exert a tensioning force in the first cable segment;
a rail; and
a lifter plate configured to receive a window, wherein the lifter plate has a first connector recess for receiving the first connector, wherein the lifter plate is drivable along the rail by the at least one drive cable.

21. A window regulator assembly as claimed in claim 20, further comprising a second connector including a second channel, wherein the second end and a second biasing member are positioned in the second channel, and wherein the second channel has a second biasing member retaining tab that is biased towards a locking position, wherein the second biasing member retaining tab is movable out of the locking position during insertion of the second end and the second biasing member into the second channel and wherein in the locking position the second biasing member retaining tab holds the second end and the second biasing member in the second channel, wherein the second biasing member is positioned between the second end and the second connector to exert a tensioning force in the second cable segment,
wherein the lifter plate has a second connector recess for receiving the second connector.

22. A window regulator assembly as claimed in claim 20, wherein the drum rotation device includes a motor.
